(19) United States
(12) Patent Application Publication
(10) Pub. No.: US 2004/0144595 A1
(43) Pub. Date: Jul. 29, 2004

(54) Ladder stabilisers

(76) Inventor: Steven Ernest Hanison, Arona (ES)

Correspondence Address: William M Lee Jr, Barnes & Thornburg, PO Box 2786, Chicago, IL, 60690-2786, US

(21) Appl. No.: 10/479,818

(22) PCT Filed: Jun. 6, 2002
(86) PCT No.: PCT/GB02/02401

(30) Foreign Application Priority Data
Jun. 6, 2001 (GB) 0113835.3

(51) Int. Cl. E06C 7/00

(52) U.S. Cl. 182/180.2

(57) ABSTRACT

A ladder stabiliser 1 comprises a metal frame (2) of substantially A-shape, comprising a pair of ground-engaging legs 3 connected by an upper cross-member (4) and a lower cross-member (5). A retaining bar 6 is mounted at an upper part of the frame (2), and serves to attach the stabiliser 1 to a ladder 10, in use. A pair of hooks 7 are mounted on the lower cross-member (5) and serve to support the lowermost rung 102 of the ladder 10 in use of the stabiliser 1. Each of the legs 3 is of adjustable height and is such that, even in the least extended position of the legs 3, the foot of the ladder 10, represented by the lowermost part of its stiles 101, is maintained clearly above ground level. This ensures that the weight of the ladder 10 is transferred to the ground 20 via the legs 3, rather than the ladder stiles 101, thereby providing a reliably wider support base for the ladder 10.

This invention relates to ladder stabilisers.

Lateral stability on ladders can be a problem. Even where a ladder is inclined at a safe angle to a wall (or other surface), it is possible for the ladder to move laterally to one side or the other about its lower points of support—for example, if a user leans too far to one side and/or if the foot of the ladder is on unstable ground.

To give ladders more stability, it is known to affix stabilisers at the foot of a ladder. Usually, such stabilisers provide an extra foot at each side of the ladder. In this way, the ladder has a wider support base.

U.S. Pat. No. 5,423,397 show one of many examples of known ladder stabilisers. In that patent, a structure engages within hollow rungs of a ladder, to support legs disposed at each side of the ladder, with ground-engaging feet. The legs are of adjustable length to accommodate sloping ground. However, in general use, the objective of this prior ladder stabiliser is, in common with others, to provide additional lateral supports to the foot of the ladder.

A particular disadvantage of this prior ladder stabiliser is that it is suitable for use only with ladders of a particular style and dimension, since the supporting structure of the stabiliser has to pass through the hollow rungs of the ladder.

A more general problem with such known arrangements is that the foot of the ladder still provides one or two points of ground support. This means that, where the ladder is subjected to a degree of lateral movement, the points of support of the ladder may shift to a single point at the foot of the ladder and a further point at the adjacent ladder stabiliser. The effect of this is that, instead of having a wide base of support there is a narrow base of support, once lateral movement has started. This can result in rapid further lateral movement, such that the ladder and its user fall unhappily to the ground.

Preferred embodiments of the present invention aim to provide ladder stabilisers that are improved in the foregoing respect and that may be used with a wide range of different ladders.

According to one aspect of the present invention, there is provided a ladder stabiliser comprising:

a) a pair of ground-engaging legs;

b) cross-member means connecting said legs;

c) attachment means for attaching the stabiliser to a ladder with the ladder between said legs; and

d) support means for supporting a ladder to which the stabiliser is attached such that the foot of the ladder is always suspended above ground level with the weight of the ladder transferred to the ground via said legs.

Preferably, said legs and cross-member means are assembled together rigidly in the form of a frame.

Preferably, said frame is of substantially A-shape.

Preferably, said legs are of independently adjustable height.

Preferably, said support means is arranged to support a ladder with the foot of the ladder at least 15 cm above the ground-engaging level of said legs.

Preferably, said cross-member means comprises an upper cross-member and a lower cross-member.

Preferably, said support means is provided on said lower cross-member.

Said support means may be adapted to engage a rung of a ladder to be supported.

Said support means may be adapted to engage opposite stiles of a ladder to be supported.

Preferably, said support means comprises hook means to engage a ladder to be supported.

Said hook means may comprise two or more hook-like support members.

Said hook means may comprise a single hook-like support member.

Said attachment means may comprise an elongate retaining member that extends from one of said legs to the other.

Said retaining member may be mounted for movement between a first, open position in which it allows a ladder to be engaged with and disengaged from the stabiliser and a second, closed position in which it retains a ladder in engagement with the stabiliser.

Said retaining member may comprise a releasable catch for retaining said retaining member in its second, closed position.

Preferably, said attachment means is disposed at an upper part of the stabiliser.

Preferably, said attachment means is disposed at one side of the stabiliser and said support means is disposed at another side of the stabiliser such that, in use, a ladder passes through the stabiliser from one side to the other.

A ladder stabiliser as above may further comprise a level indicator provided on the frame.

Said level indicator may comprise a spirit level.

Said level indicator may be provided on said upper cross-member.

Said level indicator may indicate inclination of said stabilizer in a first direction of lateral inclination of a ladder in use, and/or a second direction of fore-aft inclination of a ladder in use.

The invention extends to a ladder stabiliser according to any of the preceding aspects of the invention, in combination with a ladder to which the stabiliser is attached.

Preferably, the ladder has rungs at a regular pitch, and said support means is arranged to support the ladder with the foot of the ladder at a distance x above the ground-engaging level of said legs, which distance x is equal to at least 0.3 times said pitch.

Preferably, said distance x is in the range 0.6 to 1.0 times said pitch.

Preferably, the ladder has rungs at a regular pitch, and said support means is arranged to support the ladder with the lowermost rung of the ladder at a distance y above the ground-engaging level of said legs, which distanced y is equal to at least 1.2 times said pitch.

Preferably, said distanced y is in the range 1.4 to 2.0 times said pitch.

In another aspect, the invention provides a method of stabilising a ladder, comprising the steps of attaching to the ladder a stabiliser according to any of the preceding aspects of the invention, with the ladder between said legs of the stabiliser, and supporting the ladder by said support means of the stabiliser, such that the foot of the ladder is suspended above ground level with the weight of the ladder transferred to the ground via said legs.

For a better understanding of the invention, and to show how embodiments of the same may be carried into effect, reference will now be made, by way of example, to the accompanying diagrammatic drawings, in which:

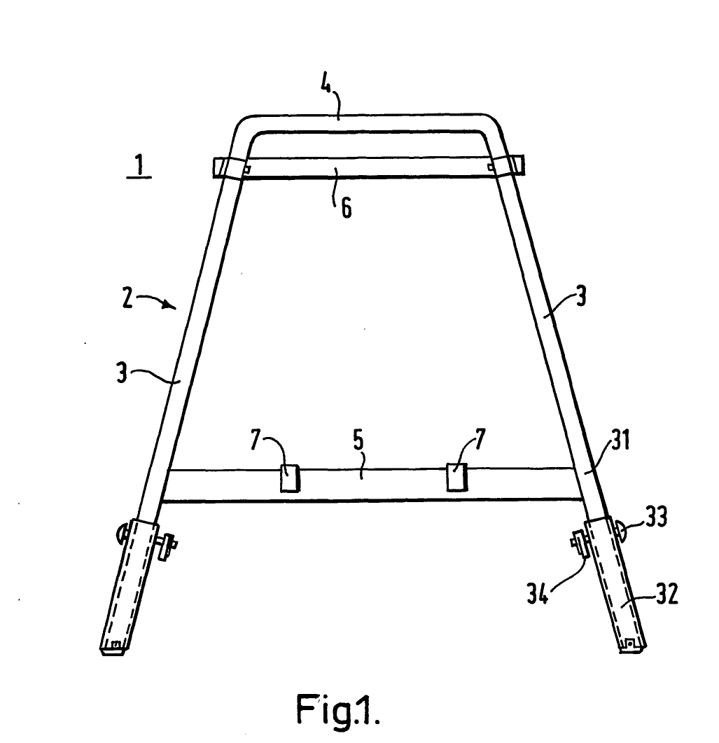

FIG. 1 is a front view of one example of a ladder stabiliser embodying the present invention;

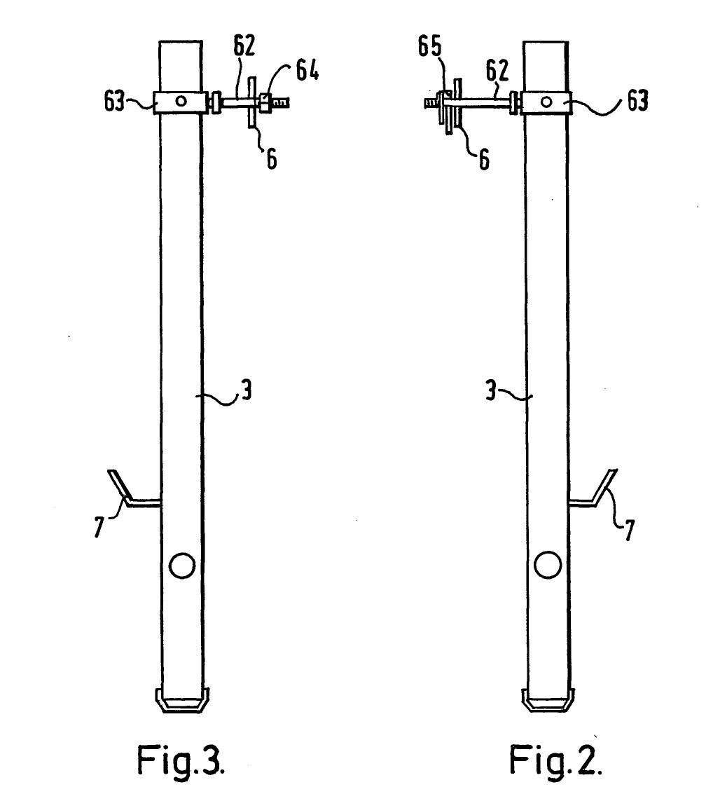

FIG. 2 is a side view of the ladder stabiliser,

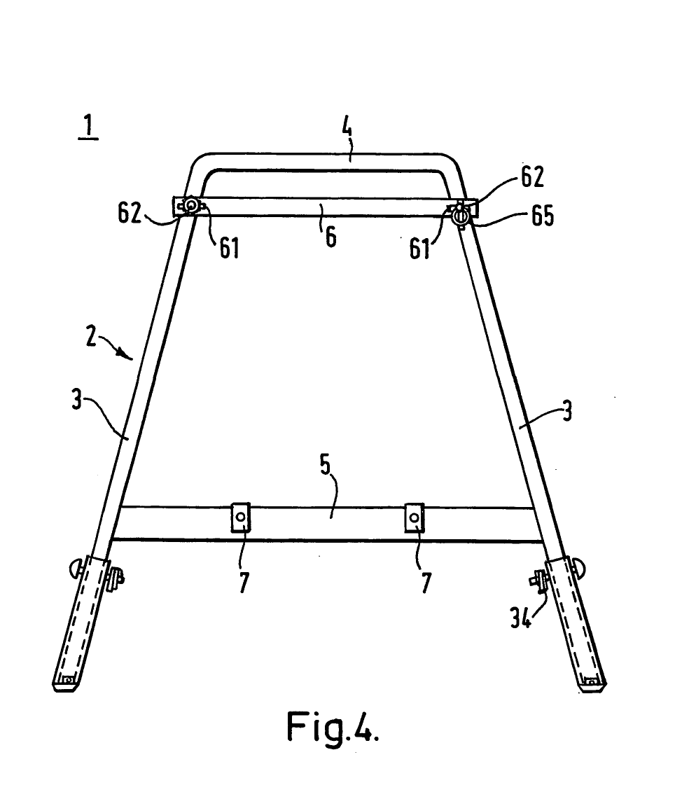

FIG. 3 is an opposite side view of the ladder stabiliser,

FIG. 4 is a rear view of the ladder stabiliser,

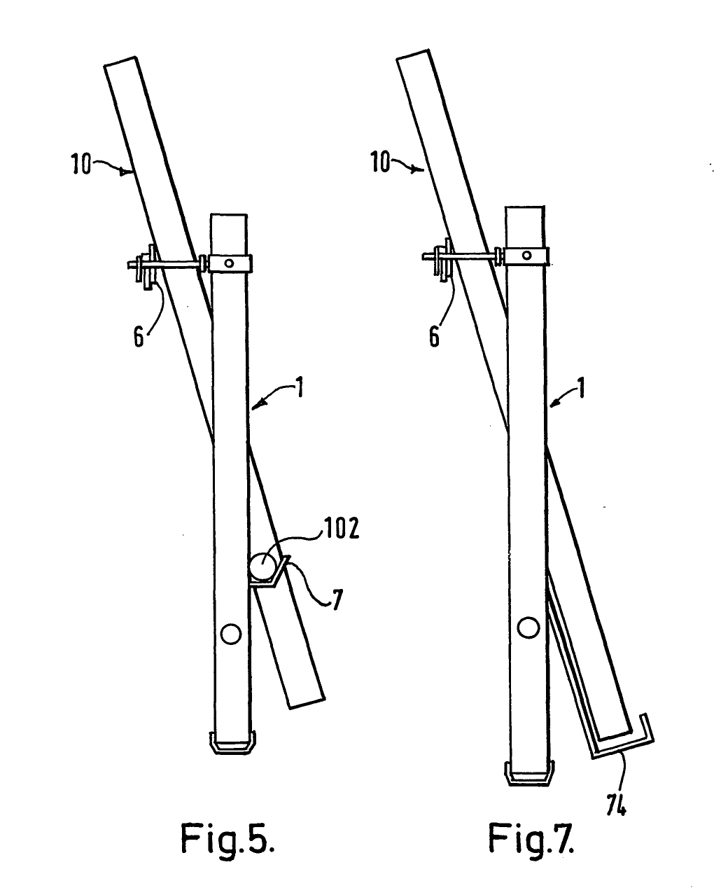

FIG. 5 is a side view of the ladder stabiliser, with a ladder in an operative, supported position;

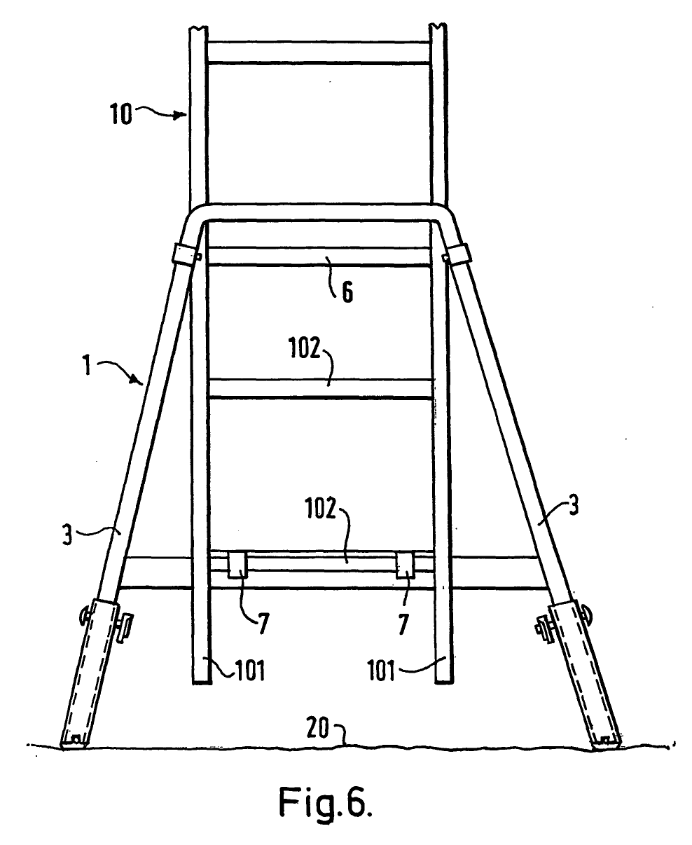

FIG. 6 is a front view of the ladder stabiliser, with the ladder in an operative, supported position;

FIG. 7 is a view similar to FIG. 5, but showing a modified ladder stabiliser with supported ladder;

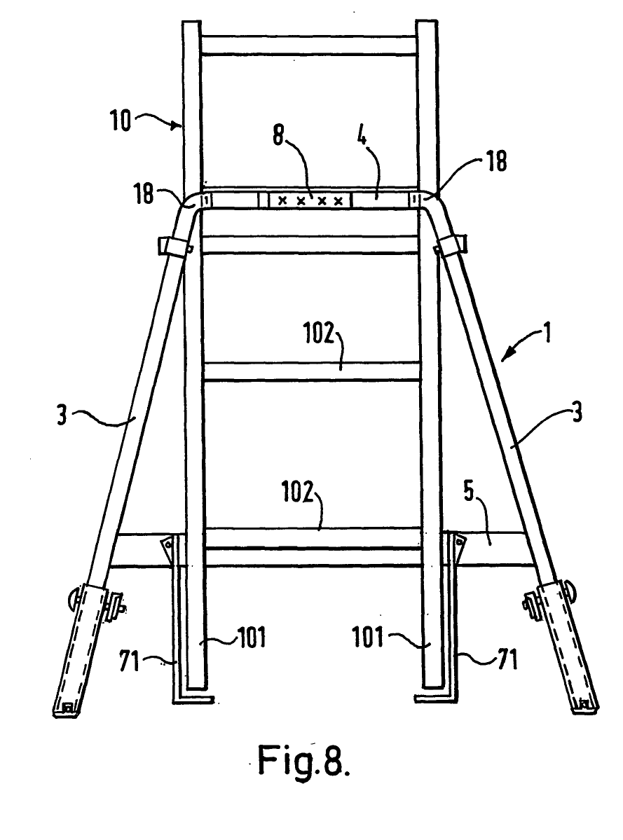

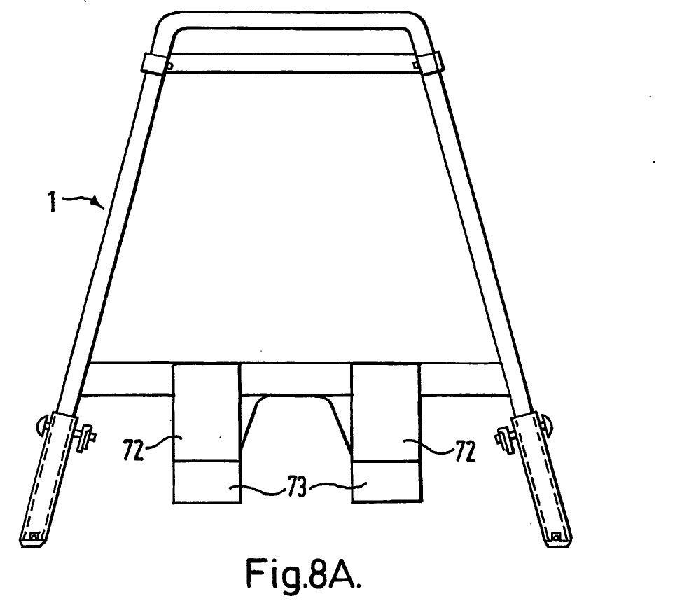

FIG. 8 is a front view of the modified ladder stabiliser of FIG. 7, with the ladder in an operative, supported position;

FIG. 8A is a view similar to FIG. 1, but showing a variation of the modified ladder stabiliser of FIG. 8;

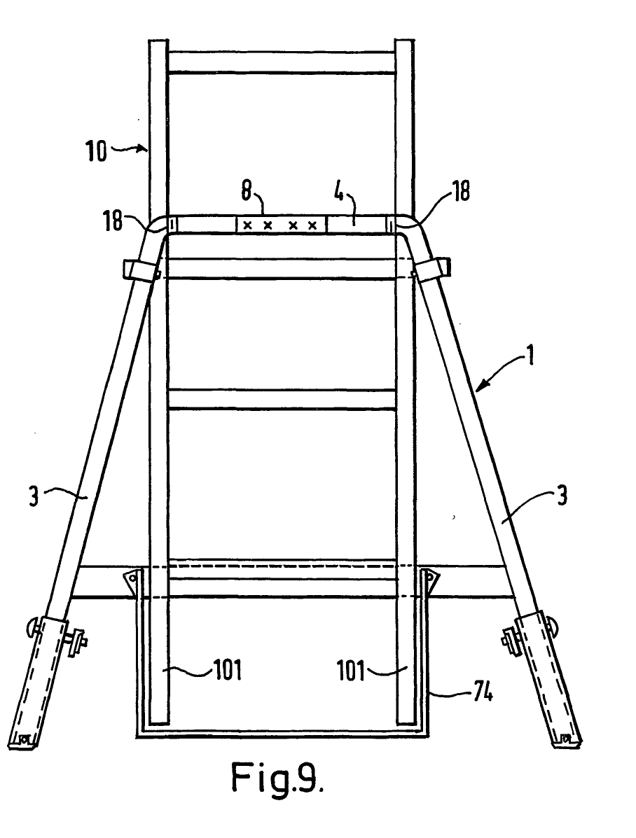

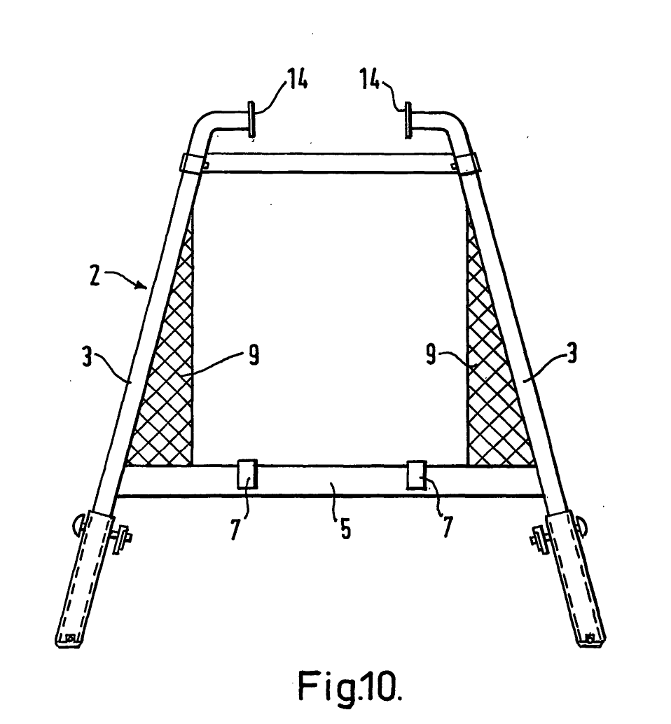

FIG. 9 is a view similar to FIG. 8, but showing another modified ladder stabiliser with supported ladder,

FIG. 10 is a view similar to FIG. 1, but showing another modified ladder stabiliser; and

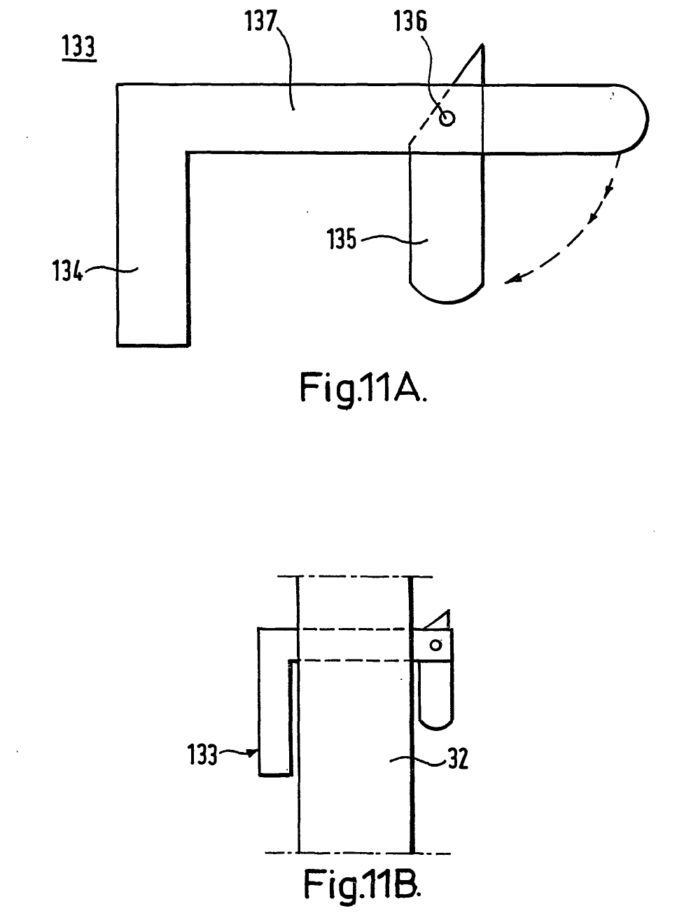

FIGS. 11A and 11B illustrate an alternative pin for use with the ladder stabiliser.

In the figures, like reference numerals denote like or corresponding parts.

The ladder stabiliser 1 that is shown in FIGS. 1 to 6 comprises a metal frame 2 of substantially A-shape, comprising a pair ground-engaging legs 3 connected by an upper cross-member 4 and a lower cross-member 5. A retaining bar 6 is mounted at an upper part of the frame 2, and serves to attach the stabiliser 1 to a ladder 10, in use. A pair of hooks 7 are mounted on the lower cross-member 5 and serve to support the ladder 10 in use of the stabiliser 1.

Each of the legs 3 is of adjustable height and, to this end, comprises a main leg portion 31 that is telescopically slideable within a lower leg portion 32. The leg portions 31 and 32 are maintained at a desired position by a pin 33 which passes through registering holes in the leg portions 31 and 32 respectively, and is retained by a retaining pin 34. A series of holes is provided on the leg portion 31 and/or the leg portion 32, to afford adjustability of the length of the leg 3. Each of the legs 3 is independently adjustable in height. Alternative configurations may be provided for adjusting the height of the legs 3.

The retaining bar 6 is formed with slots 61 at opposite ends of the bar 6. Each of the slots 61 engages a respective pin 62 which is mounted on a respective one of the legs 3 by a mounting bracket 63. One of the pins 62 is formed with a threaded end upon which a nut 64 engages, to retain the respective end of the bar 6 in engagement with the respective pin 62. The other of the pins 62 is provided with a releasable retaining pin 65, such that the respective end of the bar 6 may be brought in and out of engagement with the respective pin 62.

In use, the retaining pin 65 is removed to allow the bar 6 to be opened away from the frame 2, and a ladder such as 10 is brought adjacent the frame 2. The bar 6 is then re-engaged with the pin 62 and the locking pin 65 is replaced, to attach the stabiliser 1 to the ladder 10. The lowermost rung 102 of the ladder 10 is lowered on to the hooks 7, such that the foot of the ladder 10 is suspended above ground level, with the weight of the ladder 10 transferred to the ground 20 via the legs 3. FIGS. 5 and 6 show the stabiliser 1 in use with the ladder 10 in this way. In FIGS. 2, 3 and 5, details of the expanding parts of the legs 3 are omitted, in the interest of clarity.

It is to be appreciated that, even in the least extended position of the legs 3, the foot of the ladder 10, represented by the lowermost part of its stiles 101, is maintained above ground level. This ensures that the weight of the ladder 10 is transferred to the ground 20 via the legs 3, rather than the ladder stiles 101, thereby providing a reliably wider support base for the ladder 10. This is in contrast to previous proposals for ladder stabilisers, where the ladder 10 still maintains contact with the ground, and lateral stabilisers merely provide additional support to one or both stiles of the ladder.

Since the legs 3 are independently extendible, they may take into account any falling level of ground 20, to keep the ladder 10 substantial vertically upright, in the lateral plane. It is possible to envisage freak ground conditions in which lumps or boulders may protrude upwardly from the general level of the ground, and possibly touch the foot of one or both of the ladder stiles 101. However, in the context of this specification, references to ground level mean reasonable ground contours upon which one might reasonably contemplate use of a ladder, even if the ground is on a general incline, which can be accommodated by the independent extension of the legs 3.

FIGS. 7 and 8 illustrate a variation of the stabiliser 1, where the hooks 7 of FIGS. 1 to 6 are replaced by alternative hook-like members 71 which are mounted on the lower cross-member 5. Rather than supporting the rungs 102, the hook-like members 71 support the feet of the respective stiles 101 of the ladder 10. One advantage of this is that reliance for support of the ladder 10 does not have to be placed upon the strength of the connection between the rungs 102 and the stiles 101. Another advantage is that it can be ensured that the foot of the ladder 10 is always maintained above ground level, whatever the pitch of the rungs 102.

FIG. 8A shows a variation in which the hook-like members 71 are replaced by hook-like members 72, each of which affords a pocket-like recess 73 which is open at the top to receive a respective stile of a ladder.

In the further variation of FIG. 9, the two hook-like members 71 are replaced by a single, extended hook-like or channel-like member 74, which supports the feet of both stiles 101 of the ladder 10. The channel-like member 74 can support a range of widths of ladder 10.

In both FIGS. 8 and 9, a spirit level 8 is mounted on the upper cross-member 4, in order to indicate when the stabiliser 1 is substantially level. First of all, the spirit level indicates lateral inclination of the stabiliser 1 (and therefore the ladder 10 in use)—that is, in the views of FIGS. 8 and 9, whether the stabiliser 1 and the attached ladder 10 are leaning either to the left or to the right, or whether the stabiliser 1 and ladder 10 are substantially centred. Additionally or alternatively, the spirit level 8 may indicate the angle of inclination of the ladder 10 with respect to the wall (or other surface) against which it rests. In this respect, the spirit level may indicate a safe range of angles of use.

An alternative or addition to the spirit level 8 is the provision of gradient marks 18 on the upper cross-member 4, to indicate when the ladder 10 is central with respect to the stabiliser 1.

FIG. 10 is a view similar to FIG. 1, but indicates a variation in which the upper cross-member 4 has been largely dispensed with and two reinforcing fillets 9 are secured between the legs 3 and the cross-member 5, in order to give rigidity to the frame 2. Abutment members 14 provided at the upper ends of the legs 3 provide surfaces which may abut the stiles of a ladder, in use.

FIGS. 11A and 11B illustrate an alternative pin 133 for use with the ladder stabiliser 1, instead of the pin 33 shown in FIG. 1.

The pin 133 has a generally L-shaped body 134 and a gravity toggle 135 that is free to pivot about a pivot point 136 provided on the longer limb 137 of the L-shaped pin 133. The body 134 may be of generally circular cross-section and formed with a slot within which the toggle 135 may pivot.

In order to insert the pin 133 through the respective holes in the leg sections 31 and 32, the toggle 135 has to be brought manually into line with the limb 137. Once inserted, as shown in FIG. 11B, the toggle 135 hangs downwardly, under the influence of gravity, to prevent the pin 133 from being removed, until the toggle 135 is again brought manually into line with the limb 137.

Such a pin 133 may be particularly economical and reliable.

In a modification of the arrangement shown in FIGS. 2 and 3, each pin 62 comprises a screw-threaded rod, threaded either continuously, or at one or both ends. A threaded end of each pin 62 passes through a respective hole in the respective leg 3, and is secured to the leg 3 by a pair of nuts, each screw-threadedly engaged on the pin 62 at a respective side of the leg 3. One of the pins 62 carries at its other end a pair of nuts that are screw-threadedly engaged on the pin 62 to be locked together, thereby to serve a purpose similar to that of the illustrated nut 64. The other of the pins 62 carries at its other end the releasable retaining pin 65. The pin 62 that receives the releasable retaining pin 65 may be formed with a series of holes to receive the retaining pin 65 in different positions.

It will be appreciated that the above described and illustrated examples of stabiliser 1 can provide a ready and effective manner of stabilising any ladder 10. The stabiliser 1 and ladder 10 can be readily engaged and disengaged with one another. This has the advantage that the stabiliser 1 can quickly be removed from a ladder after use, thereby providing no impediment to existing means for the storage and transport of ladders. Since the stabiliser 1 can readily be used with a number of different ladders 10, it is not necessary to provide a separate stabiliser 1 for each ladder 10, thereby saving on expense.

The illustrated examples of stabiliser 1 may readily be used with ladders of differing dimensions. Although such variations in ladder dimensions do exist, it is generally found that the dimensions of most ladders fall within certain ranges. Thus, for example, the pitch of the rungs of the ladder is usually between 20 cm and 25 cm. Accordingly, if the hooks 7 are arranged to support the lowermost rung 102 of a ladder at a distance of at least 30 cm (and preferably 35 cm to 40 cm) above the foot of each leg 3 when completely unextended, one may be reasonably sure of supporting most ladders at a reasonable distance above the ground.

In the case of FIGS. 7 to 9, the hook-like members 71, 72 and 74 maybe arranged to support the foot of the respective ladder 10 at a minimum distance of 10 cm (and preferably 15 cm to 20 cm) above the foot of the legs 3 when unextended.

In general, support means may be arranged to support the ladder with the foot of the ladder at a distance x above the ground-engaging level of the stabiliser legs, which distance x is equal to at least 0.3 times the pitch of the rungs, and preferably in the range 0.6 to 1.0 times that pitch.

In another aspect support means may be arranged to support the ladder with the lowermost rung of the ladder at a distance y above the ground-engaging level of the stabiliser legs, which distance y is equal to at least 1.2 times the pitch of the rungs, and preferably in the range 1.4 to 2.0 times that pitch.

In the illustrated examples, the frame 2 may conveniently be made principally of tubular aluminium or other metal. However, it could be made of any other desired material.

In this specification, the verb “comprise” has its normal dictionary meaning, to denote non-exclusive inclusion. That is, use of the word “comprise” (or any of its derivatives) to include one feature or more, does not exclude the possibility of also including further features.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A ladder stabiliser comprising:
a) a pair of ground-engaging legs;
b) cross-member means connecting said legs;
c) attachment means for attaching the stabiliser to a ladder with the ladder between said legs; and
d) support means for supporting a ladder to which the stabiliser is attached such that the foot of the ladder is always suspended above ground level with the weight of the ladder transferred to the ground via said legs.

2. A ladder stabiliser according to claim 1, wherein said legs and cross-member means are assembled together rigidly in the form of a frame.

3. A ladder stabiliser according to claim 2, wherein said frame is of substantially A-shape.

4. A ladder stabiliser according to any of the preceding claims, wherein said legs are of independently adjustable height.

5. A ladder stabiliser according to any of the preceding claims, wherein said support means is arranged to support a ladder with the foot of the ladder at least 10 cm above the ground-engaging level of said legs.

6. A ladder stabiliser according to any of the preceding claims, wherein said cross-member means comprises an upper cross-member and a lower cross-member.

7. A ladder stabiliser according to claim 6, wherein said support means is provided on said lower cross-member.

8. A ladder stabiliser according to any of the preceding claims, wherein said support means is adapted to engage a rung of a ladder to be supported.

9. A ladder stabiliser according to any of the preceding claims, wherein said support means is adapted to engage opposite stiles of a ladder to be supported.

10. A ladder stabiliser according to any of the preceding claims, wherein said support means comprises hook means to engage a ladder to be supported.

11. A ladder stabiliser according to claim 10, wherein said hook means comprises two or more hook-like support members.

12. A ladder stabiliser according to claim 10, wherein said hook means comprises a single hook-like support member.

13. A ladder stabiliser according to any of the preceding claims, wherein said attachment means comprises an elongate retaining member that extends from one of said legs to the other.

14. A ladder stabiliser according to claim 13, wherein said retaining member is mounted for movement between a first, open position in which it allows a ladder to be engaged with and disengaged from the stabiliser and a second, dosed position in which it retains a ladder in engagement with the stabiliser.

15. A ladder stabiliser according to claim 13 or 14, wherein said retaining member comprises a releasable catch for retaining said retaining member in its second, closed position.

16. A ladder stabiliser according to any of the preceding claims, wherein said attachment means is disposed at an upper part of the stabiliser.

17. A ladder stabiliser according to any of the preceding claims, wherein said attachment means is disposed at one side of the stabiliser and said support means is disposed at another side of the stabiliser such that, in use, a ladder passes through the stabiliser from one side to the other.

18. A ladder stabiliser according to any of the preceding claims, further comprising a level indicator provided on the frame.

19. A ladder stabiliser according to claim 18, wherein said level indicator comprises a spirit level.

20. A ladder stabiliser according to claim 18 or 19, wherein said level indicator is provided on said upper cross-member.

21. A ladder stabiliser according to claim 18, 19 or 20, wherein said level indicator indicates inclination of said stabiliser in a first direction of lateral inclination of a ladder in use, and/or a second direction of fore-aft inclination of a ladder in use.

22. A ladder stabiliser substantially as hereinbefore described with reference to the accompanying drawings.

23. A ladder stabiliser according to any of the preceding claims, in combination with a ladder to which the stabiliser is attached.

24. A ladder and stabiliser according to claim 23, wherein the ladder has rungs at a regular pitch, and said support means is arranged to support the ladder with the foot of the ladder at a distance x above the ground-engaging level of said legs, which distance x is equal to at least 0.3 times said pitch.

25. A ladder and stabiliser according to claim 24, wherein said distance x is in the range 0.6 to 1.0 times said pitch.

26. A ladder and stabiliser according to claim 23, wherein the ladder has rungs at a regular pitch, and said support means is arranged to support the ladder with the lowermost rung of the ladder at a distance y above the ground-engaging level of said legs, which distance y is equal to at least 1.2 times said pitch.

27. A ladder and stabiliser according to claim 26 wherein said distance y is in ache range 1.4 to 2.0 times said pitch.

28. A method of stabilising a ladder, comprising the steps of attaching to the ladder a stabiliser according to any of the preceding claims, with the ladder between said legs of the stabiliser, and supporting the ladder by said support means of the stabiliser, such that the foot of the ladder is suspended above ground level with the weight of the ladder transferred to the ground via said legs.
